(19) United States
(12) Patent Application Publication
(10) Pub. No.: US 2026/0076773 A1
(43) Pub. Date: Mar. 19, 2026

(54) ORAL TRAUMA STABILIZER DEVICE

(71) Applicants: The Medical College of Wisconsin, Inc., Milwaukee, WI (US); Badger Dental Products LLC, Madison, WI (US)

(72) Inventors: David M. Poetker, Brookfield, WI (US); Kyle S. Jansson, Wauwatosa, WI (US)

(21) Appl. No.: 19/248,062

(22) Filed: Jun. 24, 2025

Related U.S. Application Data
(60) Provisional application No. 63/695,020, filed on Sep. 16, 2024.

(51) Int. Cl. A61C 5/00

(52) U.S. Cl. CPC A61C 5/007

(57) ABSTRACT

An oral trauma stabilizer includes an upper stabilizer and a lower stabilizer. A plurality of shock absorbers couple the upper stabilizer to the lower stabilizer. The upper and lower stabilizers have an arcuate body extending from a first end to a second end. A channel is formed in each arcuate body and extends along a length from the first end to the second end of the arcuate body. A cross section of each channel may vary along the length of the respective channel. In use, the oral trauma stabilizer stabilizes an injured tooth, bone, or other portion of a patient's oral anatomy using non-affected portions of the dentition or other oral anatomy to secure the oral trauma stabilizer in place.

### CROSS-REFERENCE TO RELATED APPLICATIONS

This application claims the benefit of U.S. Provisional Patent Application Ser. No. 63/695,020, filed on Sep. 30, 2024, and entitled “ORAL TRAUMA STABILIZER DEVICE,” which is herein incorporated by reference in its entirety.

### BACKGROUND

Oral trauma is a common cause for presentation to an emergency department or urgent care clinic. It can be due to falls, motor vehicle collisions, interpersonal violence, or recreation activities such as skateboarding and contact sports. Despite the commonality of the trauma, it is poorly managed in the emergency or urgent care setting due to limited availability of dental specialists. A dentist or oral surgeon can easily stabilize the loose or fractured tooth with a splinting technique. This technique, however, is time and labor intensive making it a poor option for the urgent care or emergency department provider. Fractures involving the mandible or palate will most often need surgical intervention, often performed days after the initial injury. Both scenarios leave the patient with no reasonable options for splinting or stabilizing the injury.

### SUMMARY OF THE DISCLOSURE

It is an aspect of the present disclosure to provide an oral trauma stabilizer that includes an upper stabilizer and a lower stabilizer. The upper stabilizer includes an arcuate outer side wall defining an outer periphery of the upper stabilizer, an arcuate inner side wall defining an inner periphery of the upper stabilizer, and a planar element spanning the outer side wall to the inner side wall and defining a biting surface for receiving the upper dentition of the patient. The lower stabilizer includes an arcuate outer side wall defining an outer periphery of the lower stabilizer, an arcuate inner side wall defining an inner periphery of the lower stabilizer, and a planar element spanning the outer side wall to the inner side wall and defining a biting surface for receiving the lower dentition of the patient. A plurality of shock absorbers couple the upper stabilizer to the lower stabilizer.

It is another aspect of the present disclosure to provide an oral trauma stabilizer that includes an upper stabilizer and a lower stabilizer. The upper stabilizer includes an arcuate-shaped upper stabilizer body having an upper channel to receive the upper dentition of the patient. The upper channel extends along a length from a first end of the upper stabilizer body to a second end of the upper stabilizer body. The upper stabilizer body includes a base portion, an outer side wall coupled to the base portion and defining an outer periphery of the upper stabilizer body, and an inner side wall coupled to the base portion and defining an inner periphery of the upper stabilizer body. The lower stabilizer includes an arcuate-shaped lower stabilizer body having a lower channel to receive the lower dentition of the patient. The lower channel extends along a length from a first end of the lower stabilizer body to a second end of the lower stabilizer body. The lower stabilizer body includes a base portion, an outer side wall coupled to the base portion and defining an outer periphery of the lower stabilizer body, and an inner side wall coupled to the base portion and defining an inner periphery of the lower stabilizer body. A plurality of shock absorbers extend from a lower surface of the base portion of the upper stabilizer body to an upper surface of the base portion of the lower stabilizer body to couple the upper stabilizer to the lower stabilizer.

It is yet another aspect of the present disclosure to provide an oral trauma stabilizer that includes an arcuate body having a channel to receive a plurality of teeth of a patient. The arcuate body may include a base portion, an outer side wall coupled to the base portion and defining an outer periphery of the arcuate body, and an inner side wall coupled to the base portion and defining an inner periphery of the arcuate body. The channel may include a first region to receive a first portion of the plurality of teeth and a second region to receive a second portion of the plurality of teeth. The first region of the channel has a first cross section and the second region of the channel has a second cross section that is different from the first cross section.

It is still another aspect of the present disclosure to provide an oral trauma stabilizer that includes an arcuate body extending from a first end to a second end. A channel is formed in the arcuate body and extends along a length from the first end to the second end of the arcuate body. A cross section of the channel varies along the length of the channel.

### BRIEF DESCRIPTION OF THE DRAWINGS

FIG. 1 is an example of an example oral trauma stabilizer having an upper stabilizer for stabilizing the upper dentition, palate, and/or maxilla; a lower stabilizer for stabilizing the lower dentition and/or mandible; and multiple shock absorbers that couple the upper and lower stabilizers.

FIG. 2 is another view of the oral trauma stabilizer of FIG. 1.

FIG. 3 is a front view of the oral trauma stabilizer of FIG. 1.

FIG. 4 is a side view of the oral trauma stabilizer of FIG. 1.

FIG. 5 is a top view of the oral trauma stabilizer of FIG. 1.

FIG. 6 shows detail of an example oral trauma stabilizer design and how the shape translates well to the anatomy.

FIG. 7A is an example of an oral trauma stabilizer having a channel with a variable cross section.

FIG. 7B is a plan view of an example oral trauma stabilizer illustrating different regions of the oral trauma stabilizer.

FIG. 8A shows an example cross section of an oral trauma stabilizer channel that is shaped to receive molars of a patient.

FIG. 8B shows an example cross section of an oral trauma stabilizer channel that is shaped to receive canine teeth and/or incisors of a patient.

FIGS. 9A-9F illustrate different oral trauma stabilizer cross section shapes.

FIGS. 10A and 10B show different oral trauma stabilizer cross sections in which the outer side wall (FIG. 10A) and/or inner side wall (FIG. 10B) have a rim that runs along at least a portion of the side wall's top edge.

FIGS. 11A-11C illustrate different side wall thickness profiles.

FIG. 12 is a plan view of an example oral trauma stabilizer having a removable palatal plate that spans the inner periphery of the oral trauma stabilizer.

FIG. 13 is another view of the oral trauma stabilizer of FIG. 12.

FIG. 14A is a side view of an oral trauma stabilizer showing an example of a shape of shock absorbers.

FIG. 14B a side view of an oral trauma stabilizer showing another example of a shape of shock absorbers.

FIG. 15A shows the makeup of an overmolded oral trauma stabilizer with the bodies separated.

FIG. 15B shows the makeup of an overmolded oral trauma stabilizer with the bodies together.

### DETAILED DESCRIPTION

Described here is an oral trauma stabilizer that has advantageous use in the emergency department and/or urgent care setting. The oral trauma stabilizer described in the present disclosure provides a rapid, cost-effective way to stabilize a loose or fractured tooth, a fractured alveolus, a palatal fracture, and/or a non-displaced mandible fracture until the patient can be seen by an oral trauma specialist.

In general, the oral trauma stabilizer described in the present disclosure includes a channel formed in an arcuate (e.g., curved) body. The channel is sized and shaped to be placed over the entire mandibular (i.e., lower) or maxillary (i.e., upper) dentition, depending on the location of the affected tooth and/or bone. The channel holds the affected tooth and/or bone in place and uses the stability of the healthy teeth, as well as hard tissues that are adjacent and/or remote to the injured area, to help stabilize the injured area. The oral trauma stabilizer can then be kept in place until the patient can be seen and definitively managed by an oral trauma specialist. The oral trauma stabilizer is able to better maintain the patient's dentition in place without the use of wax or other stabilizing media.

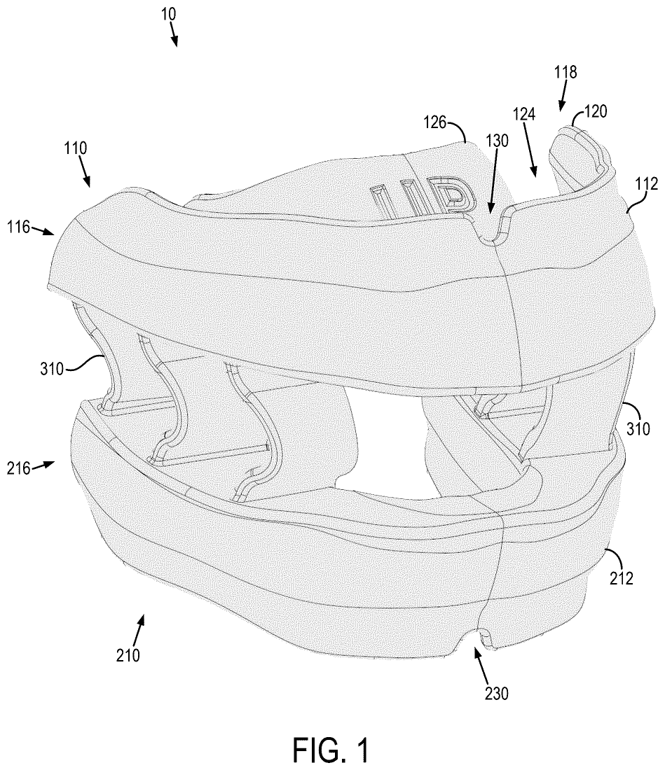

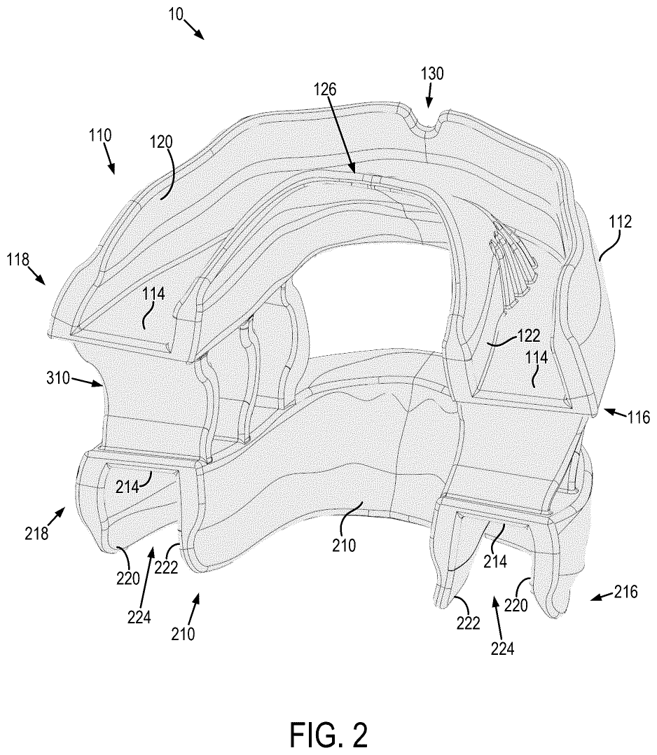

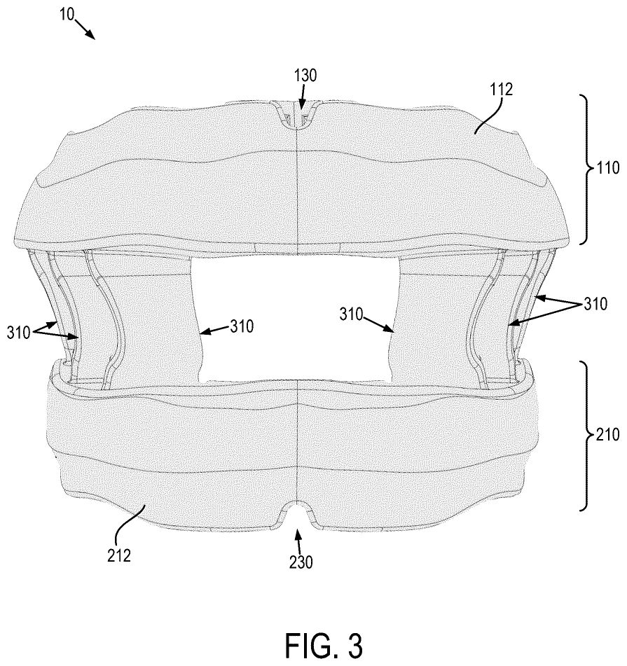

An example of an oral trauma stabilizer 10 in accordance with some embodiments described in the present disclosure is illustrated in FIGS. 1-5. The oral trauma stabilizer 10 generally includes an upper stabilizer 110 (e.g., an upper stabilizer tray, body, and/or channel) and a lower stabilizer 210 (e.g., a lower stabilizer tray, body, and/or channel). The upper stabilizer 110 is coupled with the lower stabilizer 210 by a plurality of shock absorbers 310. The shock absorbers 310 help reduce the transmission of force between the upper stabilizer 110 and the lower stabilizer 210. Additionally, the shock absorbers 310 bias the upper stabilizer 110 and/or the lower stabilizer 210 against the upper dentition or lower dentition to keep them in place and to prevent the upper stabilizer 110 from falling out due to the force of gravity. The shock absorbers 310 biasing the upper stabilizer 110 and/or lower stabilizer 210 against the patient's jaw not only provides support for stabilizing the affected dentition (e.g., the unaffected lower dentition can be used to support the affected upper dentition, or vice versa), but in case of mandibular fracture, the bias provided by the shock absorbers 310 can also help stabilize the mandible and prevent movement that may result in further injury. In this way, the oral trauma stabilizer 10 can be used not only to stabilize an affected tooth, but other oral anatomy that has been injured, including the palate, maxilla, and/or mandible.

For ease of fabrication, the oral trauma stabilizer 10 can be constructed as a single integral piece. That is, the upper stabilizer 110, lower stabilizer 210, and shock absorbers 310 may all be integrally formed as a single piece. The oral trauma stabilizer 10 can be composed of a durable material and, preferably, a durable material that is also flexible to allow for compliance of the oral trauma stabilizer 10 to individual patient anatomies. For example, the oral trauma stabilizer 10 can be composed of various plastics, polymers, silicone materials, and/or rubber, including but not limited to a thermoplastic material (e.g., a thermoplastic elastomer (TPE)), a polyethylene material, polyvinyl chloride, extruded plastic materials, polypropylene, polystyrene, extruded polystyrene, vinyl, and so on. TPEs can include thermoplastic styrenic block copolymers (TPSs), thermoplastic polyolefin elastomers (TPOs), thermoplastic vulcanizates (TPVs), thermoplastic polyurethanes (TPUs), thermoplastic copolyester (TPCs), thermoplastic polyamides (TPAs), or other unclassified TPEs.

In some instances, the oral trauma stabilizer 10 can be manufactured using injection molding techniques, or the like. As a non-limiting example, the oral trauma stabilizer 10 can be composed of an oral medical-grade silicone. In some other instances, the oral trauma stabilizer 10 can be manufactured using additive manufacturing techniques, such as 3D printing. In these instances, the oral trauma stabilizer 10 can be composed of suitable build materials, such as a biomedical flexible resin, silicone, or the like.

The upper stabilizer 110 generally includes an arcuate body 112 having a base portion 114 that extends along a length from a first end 116 to a second end 118. An outer side wall 120 is coupled to the base portion 114 and runs along the length of the base portion 114. The outer side wall 120 defines an outer periphery of the arcuate body 112. An inner side wall 122 is also coupled to the base portion 114 and runs along the length of the base portion 114. The inner side wall 122 defines an inner periphery of the arcuate body 112. Collectively, the outer side wall 120 and inner side wall 122 extend upward from the base portion 114 to define a channel 124 that extends along the length of the base portion 114 from the first end 116 to the second end 118 of the arcuate body 112.

The base portion 114 extending through the channel 124 provides a biting surface for the upper dentition. The channel 124 is generally anatomically sized and shaped to conform to or otherwise receive the upper teeth (i.e., the maxillary dentition) of the patient.

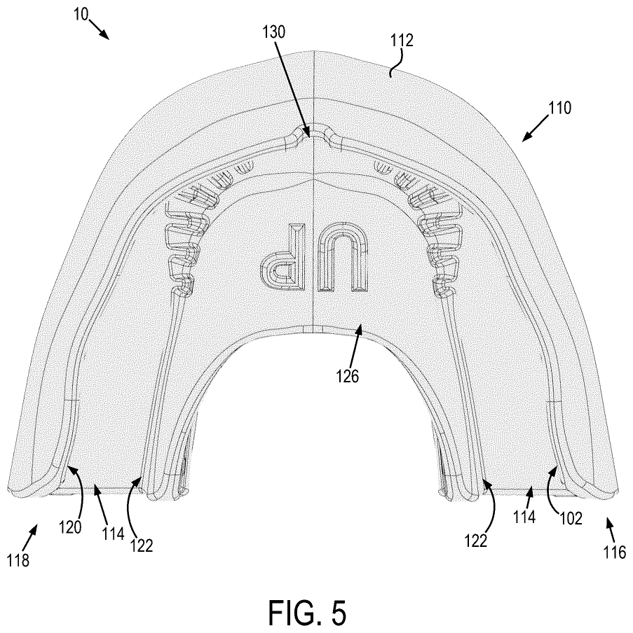

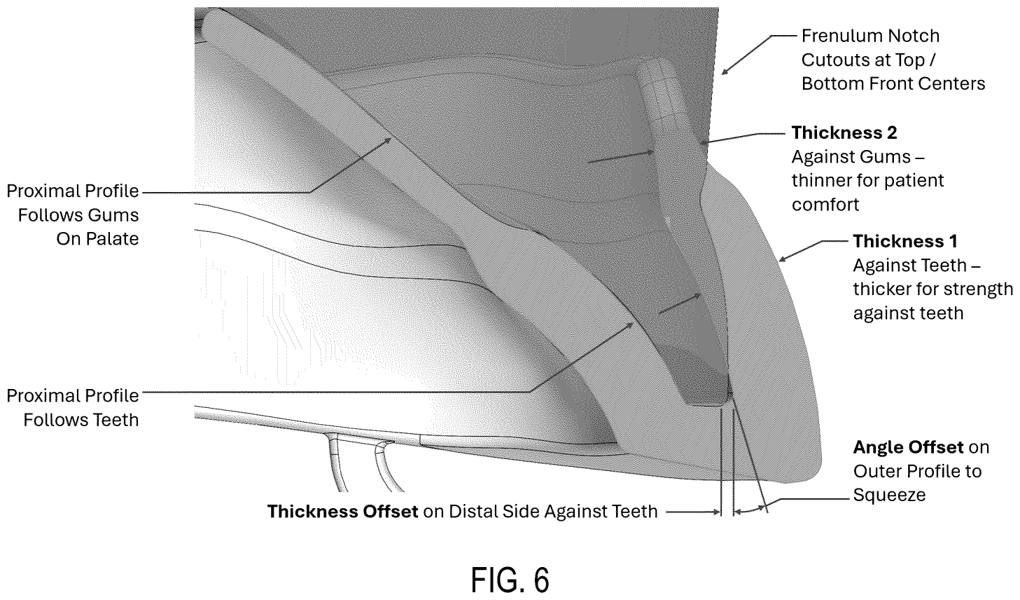

A palatal plate 126 spans the inner side wall 122 from one side of the upper stabilizer 110 to the other. Preferably, the palatal plate 126 is a curved palatal plate that conforms to the roof of the patient's mouth, as shown in FIG. 6, or is otherwise generally contoured to follow the shape of the roof of the patient's mouth. As illustrated in FIGS. 1 and 5, the palatal plate 126 can be marked (e.g., embossed, imprinted, etched, etc.) to indicate that the palatal plate 126 should be placed upwards in the patient's mouth to promote anatomic accuracy and fit.

As noted above, the oral trauma stabilizer 10, and thus the palatal plate 126, is composed of a durable, but flexible material. This allows for the palatal plate 126 to be bendable to accommodate different palate shapes and sizes and to assist clinicians and users to more easily and comfortably insert the oral trauma stabilizer 10 into the mouth. In this way, a single oral trauma stabilizer 10 design can be used to accommodate a wide range of patient anatomies. For example, two or three different designs may be capable of accommodating most patients, such as a small size to accommodate pediatric patients, a middle size to accommodate teens or smaller adults, and a larger size to accommodate larger adults.

A notch 130 is formed in the upper edge of the outer side wall 120 of the upper stabilizer 110. The notch 130 is positioned along the upper edge of the outer side wall 120 and sized to receive the frenum (e.g., the superior labial frenulum), such that the oral trauma stabilizer 10 can be comfortably positioned within the patient's mouth.

Similar to the upper stabilizer 110, the lower stabilizer 210 includes an arcuate body 212 having a base portion 214 that extends along a length from a first end 216 to a second end 218. An outer side wall 220 is coupled to the base portion 214 and runs along the length of the base portion 214. The outer side wall 220 defines an outer periphery of the arcuate body 212. An inner side wall 222 is also coupled to the base portion 214 and runs along the length of the base portion 214. The inner side wall 222 defines an inner periphery of the arcuate body 212. Collectively, the outer side wall 220 and inner side wall 222 extend downward from the base portion 214 to define a channel 224 that extends along the length of the base portion 214 from the first end 216 to the second end 218 of the arcuate body 212.

The base portion 214 extending through the channel 224 provides a biting surface for the lower dentition. The channel 224 is generally sized and shaped to conform to or otherwise receive the lower teeth (i.e., the mandibular dentition) of the patient.

Unlike the upper stabilizer 110, the lower stabilizer 210 does not include a palatal plate 126 spanning the inner side wall 222. The absence of a palatal plate 126 in the lower stabilizer 210 provides an open space that accommodates the patient's tongue when the oral trauma stabilizer 10 is in use.

Like the upper stabilizer 110, a notch 230 is formed in the lower edge of the outer side wall 220 of the lower stabilizer 210. The notch 230 is positioned along the lower edge of the outer side wall 220 and sized to receive the frenum (e.g., the inferior labial frenulum), such that the oral trauma stabilizer 10 can be comfortably positioned within the patient's mouth.

As illustrated in FIGS. 1-4, the shock absorbers 310 extend between the upper stabilizer 110 and the lower stabilizer 210. In this way, the shock absorbers 310 couple the upper stabilizer 110 and the lower stabilizer 210 together. As noted above, this coupling provides stability between the upper stabilizer 110 and the lower stabilizer 210, in addition to allowing for the upper stabilizer 110 and/or the lower stabilizer 210 to be biased against the patient's dentition (e.g., the upper dentition, the lower dentition) to stay in place. This biasing of the upper stabilizer 110 and the lower stabilizer 210 is provided by the shape and material properties of the shock absorbers.

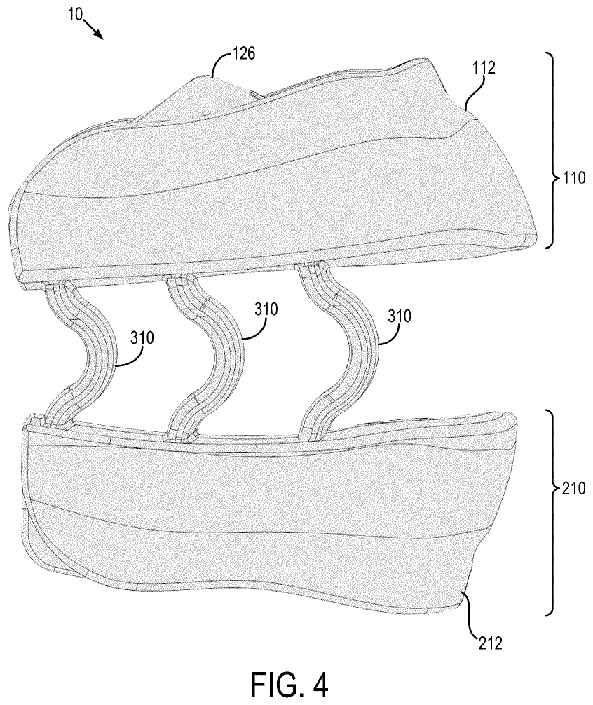

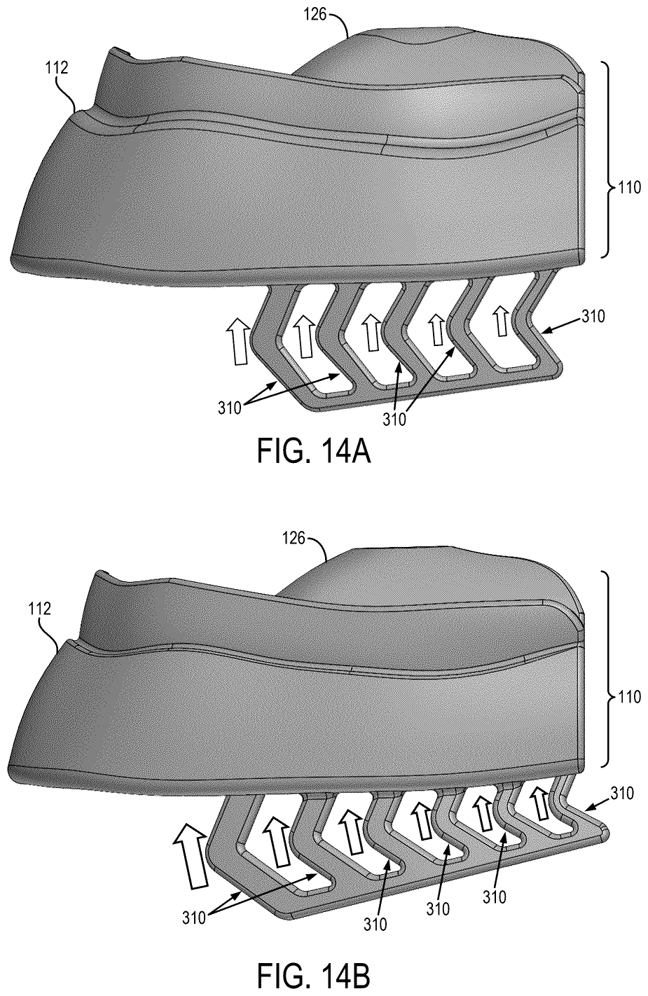

Referring to FIG. 4, for example, the shock absorbers 310 can have a curved profile. This curved profile allows for compression of the shock absorbers 310 under loading (e.g., by pressing the upper stabilizer 110 and the lower stabilizer 210 towards each other). When a load is applied to the shock absorbers 310, the curved profile of the shock absorbers 310 enables the compressed shock absorbers 310 to spring back, providing a bias that helps to secure the upper stabilizer 110 and the lower stabilizer 210 in place against the patient's dentition. Although a curved profile is illustrated in FIGS. 1-4, the shock absorbers 310 may also have other shapes, configurations, or profiles. For example, the shock absorbers 310 may alternatively have an annular profile (e.g., a circular annular profile, an elliptical annular profile, etc.), a chevron profile (e.g., as illustrated in FIGS. 14A and 14B), and so on.

As illustrated in FIGS. 1-4, a plurality of shock absorbers 310 may be arranged on each side of the oral trauma stabilizer 10. In the illustrated example, the oral trauma stabilizer 310 includes six shock absorbers 310, with three on the left side of the oral trauma stabilizer 10 and three on the right side of the oral trauma stabilizer 10. In other embodiments, the oral trauma stabilizer can have more or fewer shock absorbers 310. The shock absorbers 310 are preferably symmetrically distributed between the left and right sides of the oral trauma stabilizer 10.

The thickness of the shock absorbers 310 can be selected to provide different levels of bias against the upper stabilizer 110 and the lower stabilizer 210. In general, there is a trade-off between a thicker shock absorber 310 being stiffer and therefore providing less give. In the illustrated example, each shock absorber 310 has the same thickness. As illustrated in FIGS. 14A and 14B, the number and thickness of the shock absorbers 310 can be varied to provide different levels and gradients of bias against the upper stabilizer 110 (as illustrated in FIGS. 14A and 14B by the arrows indicating the upward force, or bias, against the upper stabilizer 110) or against the lower stabilizer 210 (not illustrated in FIGS. 14A and 14B). The angle of the shock absorbers 310 relative to the bottom surface of the upper stabilizer 110 may also be varied to provide different levels of bias.

In some cases, different shock absorbers 310 may have different thicknesses. For example, as illustrated in FIG. 14B, the shock absorbers 310 toward the front of the oral trauma stabilizer 10 may be thicker than the shock absorbers 310 towards the rear of the oral trauma stabilizer 10. Such a configuration can provide a more focused push on the premolars and may also press more into the palate. In another example, the shock absorbers 310 towards the rear of the oral trauma stabilizer 10 may be thicker than the shock absorbers 310 towards the front of the oral trauma stabilizer 10. Such a configuration can provide for more stability from the rear dentition (e.g., the molars) while allowing for more flexibility and bias force against the front dentition (e.g., incisors).

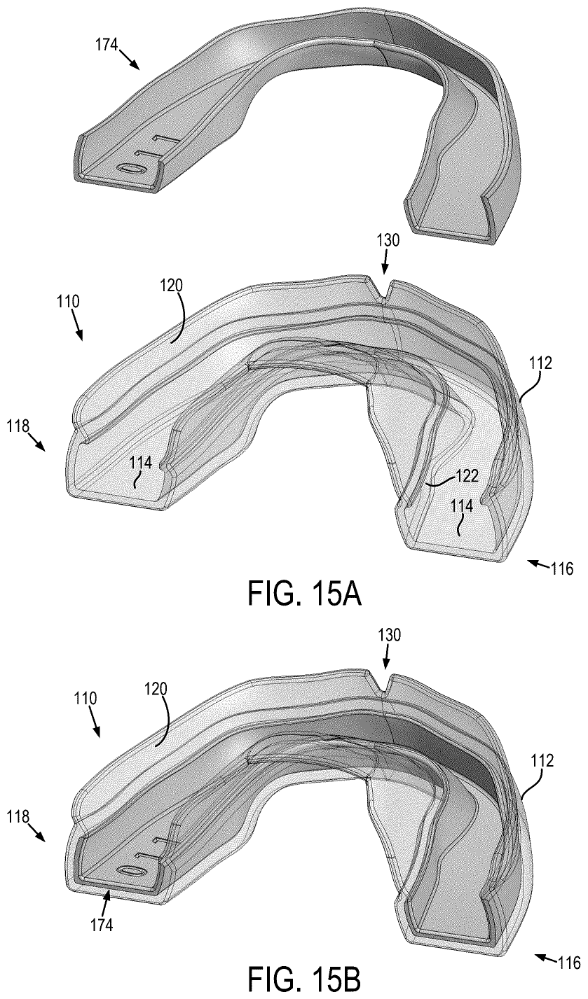

The upper stabilizer 110 and lower stabilizer 210 may be composed of a suitable material such that they are flexible but strong. This construction can provide a springiness to compress along the gums, yet conform to different teeth and gum shapes to help keep the oral trauma stabilizer 10 securely retained within the patient's mouth. In some cases, an overmold can be arranged within the channel of a given stabilizer (e.g., channer 124 of upper stabilizer 110, channel 224 of lower stabilizer 210) to provide a soft material that can accommodate variations in teeth and to be forgiving and comfortable when placed into contact with damaged teeth. An example upper stabilizer 110 with an overmold 174 arranged within the channel 124 is illustrated in FIGS. 15A (disassembled) and 15B (assembled).

As a non-limiting example, the stabilizers 110, 210 may be composed of a thermoplastic elastomer (TPE) with a hardness rating of 50 on the Shore A scale, and the overmold can be composed of a TPE with a lower hardness rating, such as a softer hardness rating of 9 on the Shore A scale. The overmold can also be composed of a TPE with a higher hardness rating, such as a hardness rating of 90 on the Shore A scale.

FIG. 6 illustrates an example channel cross-section with relevant dimensions indicated, including the thickness offset on the distal side against the teeth, the angle offset on the outer profile, a first thickness (T1) of the outer sidewall, and a second thickness (T2) of the outer sidewall. Table 1 below shows an example set of dimensions, as well as example lower and upper bounds on a range of potential dimensions.

TABLE 1
Example channel profile dimensions

| | T1, Thickness | T2, Thickness | Thickness | |
|---|---|---|---|---|
| | of Material | of Material | Offset | Angle |
| | surrounding | surrounding | against | Offset into |
| | Teeth | Gums | Teeth | Teeth/Gums |
| Revision | [inches] | [inches] | [inches] | (degrees) |
| Example | 0.15 | 0.07 | 0.015 | 15 |
| Min | 0.05 | 0.05 | 0.000 | 15 |
| Max | 0.15 | 0.12 | 0.030 | 30 |

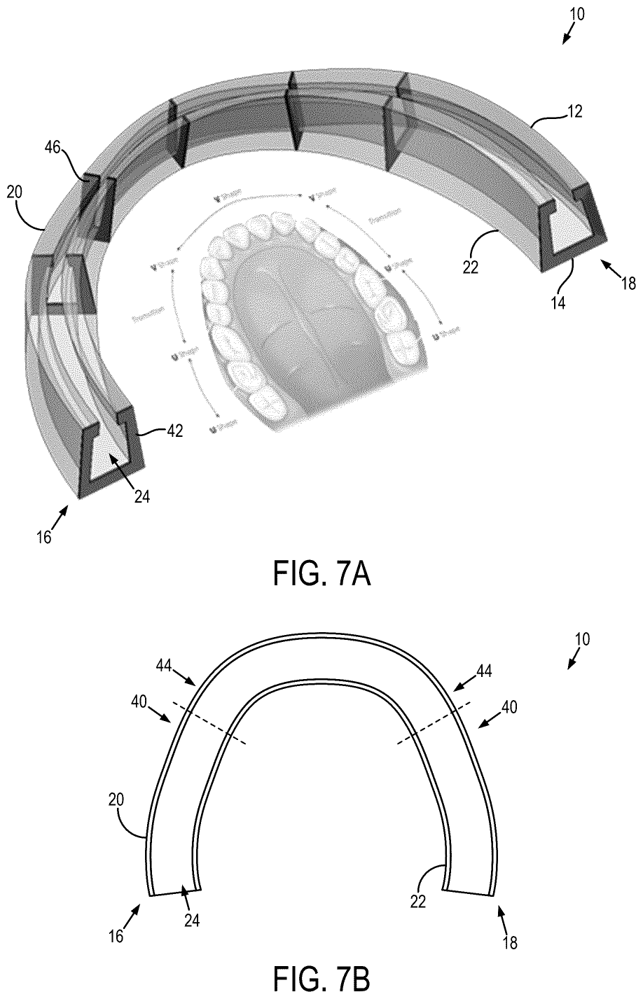

Referring now to FIGS. 7-13, another example oral trauma stabilizer 10 in accordance with some embodiments described in the present disclosure is shown. This oral trauma stabilizer 10 is constructed as a single tray for receiving either the upper dentition or the lower dentition. Alternatively, the upper stabilizer 110 and/or the lower stabilizer 210 illustrated in FIGS. 1-5 may have a similar geometry or construction as the oral trauma stabilizer 10 illustrated in FIGS. 7-13. For instance, the channel 124 of the upper stabilizer 110 and/or the channel 224 of the lower stabilizer 210 may have a geometry and/or construction similar to the tapered oral trauma stabilizer designs illustrated in FIGS. 7-13.

With initial reference to FIG. 7A, the oral trauma stabilizer 10 generally includes an arcuate body 12 having a base portion 14 that extends along a length from a first end 16 to a second end 18. An outer side wall 20 is coupled to the base portion 14 and runs along the length of the base portion 14. The outer side wall 20 defines an outer periphery of the arcuate body 12. An inner side wall 22 is also coupled to the base portion 14 and runs along the length of the base portion 14. The inner side wall 22 defines an inner periphery of the arcuate body 12. Collectively, the outer side wall 20 and inner side wall 22 extend upward from the base portion 14 to define a channel 24 that extends along the length of the base portion 14 from the first end 16 to the second end 18 of the arcuate body.

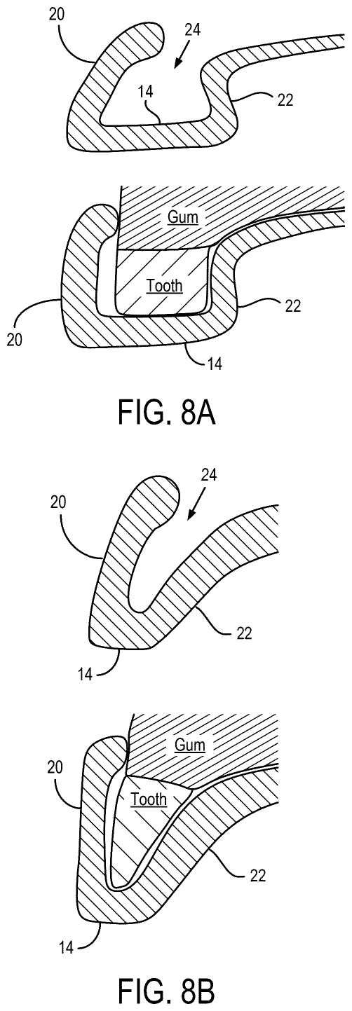

In general, the channel 24 includes two or more regions in which the cross section of the channel 24 differs to match the anatomy of the teeth. For example, as illustrated in FIGS. 7A, 8A, and 8B, the channel 24 may include a first region 40 having a first cross section 42 and a second region 44 having a second cross section 46 that is different from the first cross section 42. The first region 40 may therefore receive a first portion of the patient's teeth and the second region 44 may receive a second portion of the patient's teeth. The first region 40 and/or the second region 44 may each be a continuous region along the length of the channel 24, or may be discontinuous. For instance, as shown in FIG. 7B, the first region 40 may be split into two subregions separated along the length of the channel 24 by the second region 44. In such a configuration, the first region 40 may receive the molars of the patient, whereas the second region 44 may receive the canine teeth and incisors of the patient. In other configurations, the first region 40 and second region 44 may receive different portions of the patient's upper or lower dentition depending on the size and shape of the regions.

In some configurations, the first region 40 and the second region 44 are separated by a transition region where the cross section of the channel 24 transitions from the first cross section 42 to the second cross section 46. For instance, in the transition region the thickness of the outer side wall 20, inner side wall 22, or both, may transition from a first thickness to a second thickness. Similarly, in the transition region the angle of the outer side wall 20, inner side wall 22, or both, may transition from a first angle to a second angle.

As noted above, the first region 40 and second region 44 have different cross sections. The different cross sections can be achieved by altering the angle of the outer side wall 20, the inner side wall 22, or both, in each of the first region 40 and the second region 44. For instance, in the example illustrated in FIG. 8A, the first region 40 may have a generally U-shaped cross section and as illustrated in FIG. 8B, the second region 44 may have a generally V-shaped cross section.

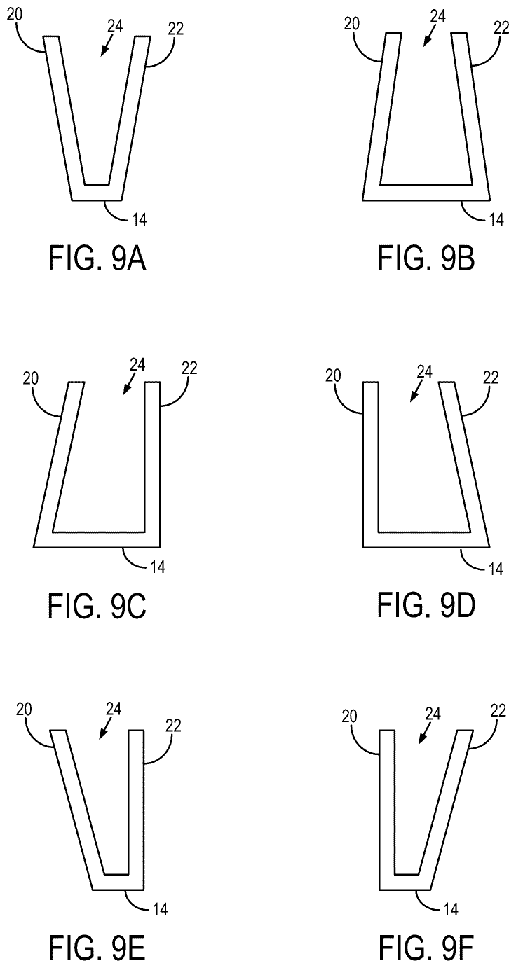

In some examples, the outer side wall 20 and the inner side wall 22 may be parallel with each other in the first region 40 of the channel 24, and the outer side wall 20 and the inner side wall 22 may be not parallel with each other in the second region 44 of the channel 24. As shown in FIG. 9A, the outer side wall 20 and the inner side wall 22 may be not parallel by angling away from each other, or as illustrated in FIG. 9B may be not parallel by angling toward each other, or as illustrated in FIGS. 9C-9F may be not parallel by having only one of the outer side wall 20 or the inner side wall 22 being angled toward or away the other side wall.

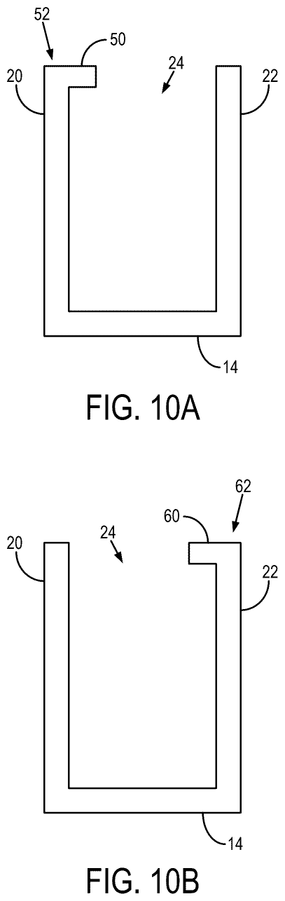

The outer side wall 20 and/or the inner side wall 22 may have a rim along their top edge that extends inwards towards a centerline of the channel 24. For instance, as illustrated in FIG. 10A, the outer side wall 20 may have a rim 50 that runs along at least a portion of the top edge 52 of the outer side wall 20. The rim 50 extends inwards towards the centerline of the channel 24 such that when a patient's tooth is received in the channel 24, the rim 50 may be biased against the patient's dentition and/or gums to provide an additional securing fit of the oral trauma stabilizer 10 within the patient's mouth. Similarly, as illustrated in FIG. 10B, the inner side wall 22 may additionally or alternatively have a rim 60 that runs along at least a portion of the top edge 62 of the inner side wall 22. The rim 60 extends inwards towards the centerline of the channel 24, such that when a patient's tooth is received in the channel 24, the rim 60 may be biased against the patient's dentition and/or gums to provide an additional securing fit of the oral trauma stabilizer 10 within the patient's mouth.

In some configurations, both the outer side wall 20 and the inner side wall 22 may have a corresponding rim 50, 60 (e.g., as illustrated in FIG. 7A). Each rim 50, 60 may run along the entire length of the channel 24, or may only run along a portion of the channel 24. For example, a rim may run along only the first region 40 of the channel 24, only the second region of the channel 24, or only a portion thereof. Additionally or alternatively, different rims may be used in different portions of the channel 24. For instance, a rim 50 may be present on the outer side wall 20 in the first region 40 of the channel 24 with no rim on the inner side wall 22 in the first region 40 of the channel 24, but a rim 60 may be present on the inner side wall 22 in the second region 44 of the channel 24 with no rim on the outer side wall 20 in the second region 44 of the channel 24. Other configurations and arrangements of one or more rims may also be implemented.

The outer side wall 20 and/or the inner side wall 22 may extend above the base portion 14 to a height that reaches the patient's gums, or may have a shorter height that does not reach the patient's gums. Having the outer side wall 20 and/or the inner side wall 22 higher on the patient's gums can provide additional grip to secure the oral trauma stabilizer 10 in the patient's mouth.

The outer side wall 20, the inner side wall 22, or both, may have a variable thickness along the length of the channel 24 or a portion thereof. Additionally or alternatively, the thickness of the outer side wall 20, the inner side wall 22, or both, may be constant along the length of the channel 24 or a portion thereof. For instance, in some configurations the outer side wall 20 may have a constant thickness along the entire length of the channel 24, whereas the inner side wall 22 may have a variable thickness along at least a portion of the channel 24. The thickness of the inner side wall 22 may vary along the length of the channel 24, may vary along the height of the inner side wall 22, or both. Similarly, in some configurations the inner side wall 22 may have a constant thickness along the entire length of the channel 24, whereas the outer side wall 20 may have a variable thickness along at least a portion of the channel 24. The thickness of the outer side wall 20 may vary along the length of the channel 24, may vary along the height of the outer side wall 20, or both. In still other configurations, the thickness of both the outer side wall 20 and the inner side wall 22 may vary along at least a portion of the channel. In these instances, the thickness of the outer side wall 20 and/or inner side wall 22 may vary along the length of the channel 24, may vary along the height of the respective side wall, or both.

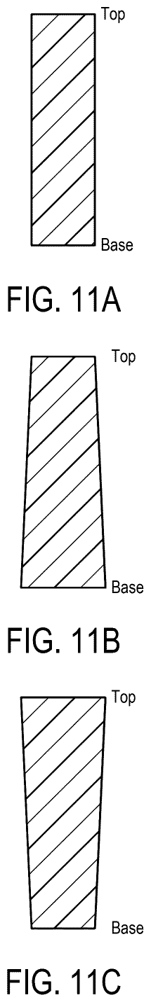

FIG. 11A illustrates an example of a side wall, which may be an outer side wall 20 and/or an inner side wall 22, having a constant thickness along its height. FIG. 11B illustrates an example of a side wall, which may be an outer side wall 20 and/or an inner side wall 22, having a variable thickness along its height. In the illustrated example, the thickness of the side wall is tapered such that the side wall is thicker at its base than at its top. FIG. 11C illustrates another example of a side wall, which may be an outer side wall 20 and/or an inner side wall 22, having a variable thickness along its height. In this illustrated example, the thickness of the side wall is tapered such that the side wall is thinner at its base than at its top.

The thickness of the side walls may also vary along the length of the channel 24. For instance, the thickness of the outer side wall 20, the inner side wall, or both, may have a different thickness in the first region 40 of the channel 24 than in the second region 44 of the channel 24. The side walls may have any suitable combination of different thicknesses along the length of the channel 24.

The first cross section 42 and the second cross section 46 may therefore be configured by adjusting the thickness and/or angle of the outer side wall 20 and/or the inner side wall 22 along different portions of the length of the channel 24. In some configurations, it is advantageous for the first cross section 42 in the first region 40 to be shaped such that a more secure fit against the patient's dentition can be provided in the first region 40, whereas the second cross section 46 in the second region 44 can be shaped such that the dentition in the second region 44 are cradled to protect an affected tooth in the second region 44.

In some configurations, the outer side wall 20, the inner side wall 22, or both, may include a notch along the top edge of the respective side wall in the central portion of the arcuate body 12 to accommodate the frenulum (upper or lower) of the patient.

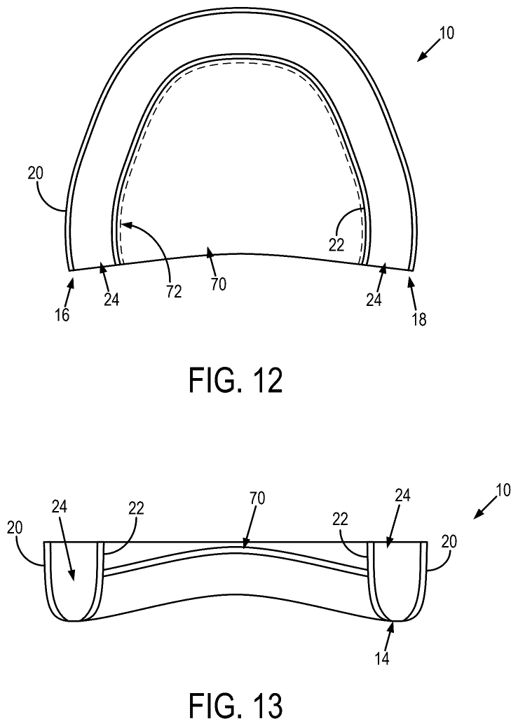

In some configurations, such as those shown in FIGS. 12 and 13, the oral trauma stabilizer 10 may include a palatal plate 70 that spans the inner periphery of the arcuate body 12 (e.g., by spanning the inner periphery of the inner side wall 22 from the first end 16 of the base portion 14 to the second end 18 of the base portion 14). The palatal plate is a curved planar element that conforms to the roof of the patient's mouth, or is otherwise generally contoured to follow the shape of the roof of the patient's mouth. The palatal plate 70 can be removable, such that a single oral trauma stabilizer 10 design can be modified to accommodate both the upper dentition (e.g., with the palatal plate 70 in place) and the lower dentition (e.g., with the palatal plate 70 removed to accommodate the tongue). The palatal plate 70 can be removably coupled to the inner side wall 22 via perforations (e.g., as indicated by dashed line 72), can be cut away, or the like. For example, a number of perforations can be formed in the palatal plate adjacent the inner side wall 22 and along the length of the inner periphery (e.g., along the length of the channel 24), such that the palatal plate 70 may be removed by breaking the perforations. The perforations may have any number, size, or shape, as suitable to provide a removable coupling of the palatal plate 70 to the inner side wall 22. In other configurations, the palatal plate 70 may be removed by cutting the palatal plate 70 away from the inner side wall 22, or the like.

As described above, the oral trauma stabilizer 10 can be composed of a flexible material, including but not limited to a thermoplastic material, such as thermoplastic elastomers (TPE), a polyethylene (PE) material, polyvinyl chloride, polypropylene, polystyrene, vinyl, silicone, or rubber and so on. In some instances, the oral trauma stabilizer 10 can be manufactured using additive manufacturing techniques, such as 3D printing. In these instances, the oral trauma stabilizer 10 can be composed of suitable build materials, such as biomedical grade flexible materials.

When a patient who has suffered an oral trauma that results in one or more teeth being loosened, fractured, or both; the bony alveolus being fractured; a palatal fracture; and/or a non-displaced mandible fracture, the oral trauma stabilizer described in the present disclosure can be used to stabilize the affected anatomy until a specialist is able to treat the patient. The oral trauma stabilizer is positioned within the patient's mouth. The oral trauma stabilizer may be oversized, such that the oral trauma stabilizer may be pinched and then fit into place in patients with a smaller mouth. When the oral trauma stabilizer has been properly positioned, the patient is instructed to gently bite down on the oral trauma stabilizer. Because the arcuate body of the oral trauma stabilizer has a pliable, yet stable, consistency, the affected tooth and/or bone is able to be received within the channel of the oral trauma stabilizer without aggravating or otherwise worsening the condition of the injured area. The channel then holds the affected tooth in place until the patient can be seen by a specialist. Furthermore, by having the adjacent, healthy teeth also received into the channel, these adjacent teeth are able to further stabilize the affected tooth and/or bone. Likewise, hard tissues that are adjacent and/or remote to the injured area (e.g., affected tooth, or other affected dental anatomy) can also provide support when the oral trauma stabilizer is positioned within the patient's mouth. Flexibility will assist in the clinician and user to remove the oral trauma stabilizer as it will not have any connection to teeth or gums to comfortably and safely be removed without further trauma to the patient.

In this way, the oral trauma stabilizer enables the patient to be treated in the emergency department or urgent care clinic setting while greatly reducing the risk of additional trauma to the injured area (e.g., affected tooth, affected bone). Then, after the patient has been treated in the emergency department or urgent care clinic setting, the patient can be seen by a specialist, who will remove the oral trauma stabilizer to gain access to the injury and treat the patient appropriately.

The present disclosure has described one or more preferred embodiments, and it should be appreciated that many equivalents, alternatives, variations, and modifications, aside from those expressly stated, are possible and within the scope of the invention.

1. An oral trauma stabilizer, comprising:
an upper stabilizer comprising:
an arcuate outer side wall defining an outer periphery of the upper stabilizer;
an arcuate inner side wall defining an inner periphery of the upper stabilizer;
a planar element spanning the outer side wall to the inner side wall and defining a biting surface configured for receiving the upper dentition of a patient;
a lower stabilizer comprising:
an arcuate outer side wall defining an outer periphery of the lower stabilizer;
an arcuate inner side wall defining an inner periphery of the lower stabilizer;
a planar element spanning the outer side wall to the inner side wall and defining a biting surface configured for receiving the lower dentition of the patient; and
a plurality of shock absorbers coupling the upper stabilizer to the lower stabilizer;
wherein the upper stabilizer, lower stabilizer, and plurality of shock absorbers are integrally formed as a single piece.

2. The oral trauma stabilizer of claim 1, wherein the upper stabilizer further comprises a palatal plate spanning from one side of the arcuate inner side wall of the upper stabilizer to another side of the arcuate inner side wall of the upper stabilizer.

3. The oral trauma stabilizer of claim 1, further comprising a notch formed in at least one of:
an upper edge of the outer side wall of the upper stabilizer, wherein the notch is configured to receive a superior labial frenulum of the patient; or
a lower edge of the outer side wall of the lower stabilizer, wherein the notch is configured to receive an inferior labial frenulum of the patient.

4. The oral trauma stabilizer of claim 1, wherein the plurality of shock absorbers are symmetrically distributed between a left side of the oral trauma stabilizer and a right side of the oral trauma stabilizer.

5. The oral trauma stabilizer of claim 1, wherein each of the plurality of shock absorbers has a curved profile that provides a bias against the upper stabilizer and the lower stabilizer when compressed.

6. An oral trauma stabilizer, comprising:
an upper stabilizer, comprising an arcuate-shaped upper stabilizer body having an upper channel to receive an upper dentition of a patient, wherein the upper channel extends along a length from a first end of the upper stabilizer body to a second end of the upper stabilizer body, the upper stabilizer body comprising:
a base portion;
an outer side wall coupled to the base portion and defining an outer periphery of the upper stabilizer body;
an inner side wall coupled to the base portion and defining an inner periphery of the upper stabilizer body;
a lower stabilizer, comprising an arcuate-shaped lower stabilizer body having a lower channel to receive a lower dentition of the patient, wherein the lower channel extends along a length from a first end of the lower stabilizer body to a second end of the lower stabilizer body, the lower stabilizer body comprising:
a base portion;
an outer side wall coupled to the base portion and defining an outer periphery of the lower stabilizer body;
an inner side wall coupled to the base portion and defining an inner periphery of the lower stabilizer body;
a plurality of shock absorbers extending from a lower surface of the base portion of the upper stabilizer body to an upper surface of the base portion of the lower stabilizer body to couple the upper stabilizer to the lower stabilizer;
wherein the plurality of shock absorbers are integrally formed with the upper stabilizer body and the lower stabilizer body.

7. The oral trauma stabilizer of claim 6, wherein the upper stabilizer body further comprises a palatal plate spanning from one side of the inner side wall of the upper stabilizer body to another side of the inner side wall of the upper stabilizer body.

8. The oral trauma stabilizer of claim 6, wherein each of the plurality of shock absorbers has a curved profile that provides a bias against the upper stabilizer body and the lower stabilizer body when compressed.

9. The oral trauma stabilizer of claim 6, wherein at least one of the upper channel or the lower channel has a cross section that varies along the length of the at least one of the upper channel or the lower channel.

10. The oral trauma stabilizer of claim 9, wherein the cross section of the at least one of the upper channel or the lower channel is tapered in a central portion of the length of the at least one of the upper channel or the lower channel.

11. The oral trauma stabilizer of claim 6, wherein at least one of the upper channel or the lower channel has a first cross section in a first region and a second cross section in a second region.

12. The oral trauma stabilizer of claim 11, wherein the first cross section is a U-shaped cross section.

13. The oral trauma stabilizer of any one of claim 11 or 12, wherein the second cross section is a V-shaped cross section.

14. An oral trauma stabilizer, comprising:
an arcuate body having a channel configured to receive a plurality of teeth of a patient, the arcuate body comprising:
a base portion;
an outer side wall coupled to the base portion and defining an outer periphery of the arcuate body;
an inner side wall coupled to the base portion and defining an inner periphery of the arcuate body;
wherein the channel comprises a first region configured to receive a first portion of the plurality of teeth and a second region configured to receive a second portion of the plurality of teeth; and
wherein the first region of the channel has a first continuous cross section and the second region of the channel has a second continuous cross section that is different from the first continuous cross section.

15. The oral trauma stabilizer of claim 14, wherein the outer side wall and the inner side wall are parallel to each other in the first region of the channel and the outer side wall and the inner side wall are not parallel to each other in the second region of the channel.

16. The oral trauma stabilizer of claim 14, wherein the outer side wall and the inner side wall are angled away from each other in the second region.

17. The oral trauma stabilizer of claim 14, wherein the outer side wall and the inner side wall are angled toward each other in the second region.

18. The oral trauma stabilizer of claim 14, wherein the first portion of the plurality of teeth comprise molars.

19. The oral trauma stabilizer of claim 14, wherein the second portion of the plurality of teeth comprise canine teeth and incisors.

20. The oral trauma stabilizer of claim 14, wherein the first continuous cross section is a U-shaped cross section.

21. The oral trauma stabilizer of claim 14, wherein the second continuous cross section is a V-shaped cross section.

22. The oral trauma stabilizer of claim 14, wherein a thickness of at least one of the outer side wall or the inner side wall is different in the first region than in the second region.

23. The oral trauma stabilizer of claim 22, wherein the thickness of both the outer side wall and the inner side wall is thicker in the second region than in the first region.

24. An oral trauma stabilizer, comprising:
an arcuate body extending from a first end to a second end; and
a channel formed in the arcuate body and extending along a length from the first end to the second end of the arcuate body, wherein a cross section of the channel smoothly varies along the length of the channel.

25. The oral trauma stabilizer of claim 24, wherein the cross section of the channel is tapered in a central portion of the length of the channel.

26. The oral trauma stabilizer of claim 24, wherein the arcuate body comprises an outer side wall defining an outer periphery of the arcuate body and an inner side wall defining an inner periphery of the arcuate body, wherein the channel is arranged between the outer side wall and the inner wall.

27. The oral trauma stabilizer of claim 26, wherein a thickness of at least one of the outer side wall or the inner side wall is constant along the length of the channel.

28. The oral trauma stabilizer of claim 26, wherein a thickness of at least one of the outer side wall or the inner side wall is variable along the length of the channel.

29. The oral trauma stabilizer of claim 28, wherein the thickness of at least one of the outer side wall or the inner side wall is tapered.

30. The oral trauma stabilizer of claim 26, further comprising a palatal plate spanning the inner periphery of the arcuate body from the first end of the arcuate body to the second end of the arcuate body, wherein the palatal plate is configured to conform to a roof of a patient's mouth.
